(19) United States
(12) Patent Application Publication
(10) Pub. No.: US 2004/0168415 A1
(43) Pub. Date: Sep. 2, 2004

(54) Centrifugal separator

(75) Inventors: Torsten Hilpert, Erdmannhausen (DE); Heinz Buehl, Erlenbach (DE)

Correspondence Address: CROWELL & MORING LLP, INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 10/715,830

(22) Filed: Nov. 19, 2003

(30) Foreign Application Priority Data
Nov. 20, 2002 (DE) 102 54 034.9

(51) Int. Cl. B01D 45/14

(52) U.S. Cl. 55/406

(57) ABSTRACT

A centrifugal separator (1) for separating impurities entrained in a gas stream (2), in which the centrifugal separator (1) includes at least one rotatable separating member and a turbine wheel (4) for driving the separating member (3).

### BACKGROUND OF THE INVENTION

The present invention relates to a centrifugal separator for separating impurities entrained in a gas stream and comprising at least one rotatable separating member.

Centrifugal separators for separating impurities entrained in a gas stream are used in many different applications. Particularly in internal combustion engines of motor vehicles, so-called blow-by gases must be discharged from a crankcase of the internal combustion engine using a crankcase ventilation system. The blow-by gases are supplied to an intake tract that takes in combustion air for the internal combustion engine. To obtain good engine performance and low emission values, impurities such as oil mists or the like must be removed from the blow-by gases. Centrifugal separators are used particularly in truck engines in which a rotatable separating member in the crankcase ventilation system flings entrained oil particles in an outward direction by centrifugal force. The collected oil separated from the gas stream can then be removed.

Effective separation requires the separating member to rotate at high speeds, for example, ranging around 1800 RPM. The drive of the separating member requires a certain amount of power, which in conventional designs is provided by a costly electric motor. In addition to the electric motor itself, a power supply protected against dirt and corrosion and a corresponding motor control are required, which leads to further costs.

To take into account the different operating parameters and the different purification tasks, a correspondingly designed control of the electric motor is required. The motor itself has to be designed for the maximum required speed or output. At lower speeds or outputs, this electric motor is then overdimensioned and runs at an inefficient operating level.

### SUMMARY OF THE INVENTION

Accordingly, it is an object of the invention to provide an improved centrifugal separator for separating entrained oil from a gas stream in a crankcase ventilation system.

Another object of the invention is to provide a centrifugal separator which has a simpler and less expensive drive.

A further object of the invention is to provide a centrifugal separator with a high degree of operating flexibility.

These and other objects are achieved in accordance with the present invention by providing a centrifugal separator for separating contaminants entrained in a gas stream, wherein the centrifugal separator comprises at least one rotatable separating member, and a turbine wheel for driving the separating member.

In accordance with the invention, a turbine wheel driven by a gas stream is provided to drive a rotatable separating member of the centrifugal separator. Such a turbine wheel used as the power source is small, lightweight and easy to manufacture. It offers good drive power even if the operating parameters vary. If the turbine wheel is appropriately mounted, the resulting turbine is practically maintenance free and has a long service life. The desired turbine output can be regulated or controlled via the driving gas stream in a simple and cost-effective manner.

Many suitable gas stream sources are available, particularly when such a centrifugal separator is used on an internal combustion engine,. In one advantageous embodiment, the turbine wheel is driven by the pressure difference between the upstream and downstream sides of a throttle valve in an air intake tract of the internal combustion engine. In such a case, the turbine wheel is disposed in a bypass line which bypasses the throttle valve.

Depending on the position of the throttle valve, the pressure difference between the upstream and downstream sides thereof will be higher or lower. The pressure difference causes an air stream to form, which flows through the bypass line. This air stream has sufficient energy density to drive the turbine wheel. When this air stream impinges on the turbine wheel, the wheel itself is not subjected to any extraordinary mechanical or thermal loads. The entire turbine drive, including the bearing assembly, the housing and associated lines can be constructed simply and cost-effectively.

In one advantageous alternative embodiment, the turbine wheel can be driven by the pressure difference of a loader, particularly an exhaust driven turbocharger. This variant is comparable to the embodiment described above; the only difference is that the bypass line runs from the high-pressure part of the loader across the turbine wheel to the low-pressure part. Such a loader can produce high pressure differences. As a result the turbine wheel can be made particularly small to save space.

Exhaust turbochargers are typically overdimensioned for full-load operation of the internal combustion engine so that they will still deliver sufficient charging capacity at low engine outputs. As a result, diverting a gas stream to drive the rotatable separating member in the centrifugal separator does not reduce the charging capacity at average and relatively high engine outputs. Thus, the performance of the internal combustion engine is not affected.

The rotatable separating member in the arrangement according to the invention can have any configuration. An embodiment of the separating member as a separating plate or disk separator has proven to be advantageous. While the required drive power is low, the disk separator has a high separation action. If the separator is driven by a turbine wheel, the desired separation efficiency can be controlled or regulated over a wide speed range and thus over a wide range of action.

In another advantageous embodiment, the separating member and the turbine wheel are arranged along the same axis. This enables a simple drive transmission from the turbine wheel to the separating member and avoids additional complexity, e.g., a gear or belt drive.

A coupling is advantageously provided between the separating member and the turbine wheel. This coupling can fulfill various functions, such as dismountability, compensation of positional and angular tolerances and/or vibration prevention. In particular, the coupling is configured as a connectable and disconnectable coupling. At certain operating points, the centrifugal separator can thus be connected or disconnected. Insofar as disconnection is not required, the turbine wheel can freely rotate in the disconnected state without drawing any appreciable energy from the driving gas stream.

An advantageous compromise with respect to drive power, overall volume, production costs and service life is obtained if the turbine wheel is configured as part of a radial flow turbine.

### BRIEF DESCRIPTION OF THE DRAWINGS

The invention will be described in further detail hereinafter with reference to illustrative preferred embodiments shown in the accompanying drawing figures, in which:

FIG. 1 is a schematic view of a centrifugal separator comprising a turbine wheel driven by the pressure difference between the upstream and downstream side of a throttle valve and a plurality of disk separators driven by the turbine wheel; and

FIG. 2 shows a variant of the arrangement illustrated in FIG. 1 with a turbine wheel driven by the pressure from an exhaust turbocharger.

### DETAILED DESCRIPTION OF PREFERRED EMBODIMENTS

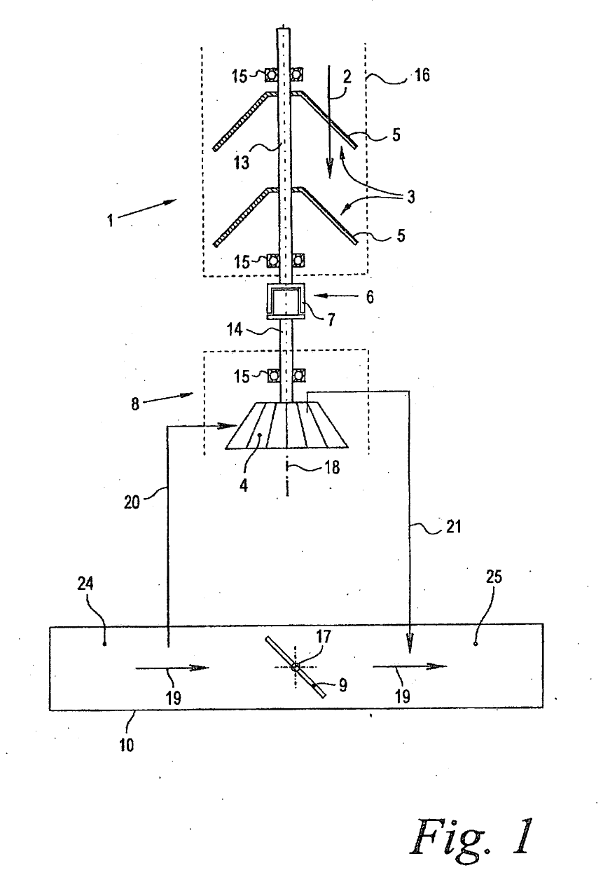

FIG. 1 is a schematic illustration of a centrifugal separator 1 with a plurality of rotatable separating members 3. In the embodiment shown, the separating members 3 are arranged in a crankcase ventilation system 16 of an internal combustion engine (not shown). A gas stream indicated by an arrow 2 flows through the crankcase ventilation system 16. To separate contaminants entrained in the gas stream 2, at least one rotatable separating member 3 is provided. In the embodiment shown, two separating members 3 represent a plurality thereof. The separating members 3 can have any suitable design. In the embodiment shown they are configured as generally conical disk separators 5.

To drive the separating members 3, a schematically indicated radial flow turbine 8 with a turbine wheel 4 is provided. Depending on the application, an axial flow turbine or the like may be advantageous. The turbine wheel 4 is mounted on a shaft 14 and the separating members 3 on a shaft 13. The separating members 3 and the turbine wheel 4 are arranged along the same axis, such that the shafts 13, 14 together with the separating members 3 and the turbine wheel 4, respectively, are supported for rotation about a common axis 18 by bearing assemblies 15.

A coupling 6 connecting the two shafts 13, 14 is provided between the separating members 3 and the turbine wheel 4. This coupling 6 is configured as a connectable and disconnectable coupling 7.

The internal combustion engine (not shown) has an air intake tract 10 for taking in an intake air stream indicated by arrows 19. The intake air stream 19 is controlled by a throttle valve 9 which is pivotable about a pivot axis 17 to control the power of the internal combustion engine. When the throttle valve 9 is at least partially closed, a high-pressure side 24 is formed upstream of the throttle valve 9 and a low-pressure side 25 downstream thereof.

The turbine wheel 4 is driven by the pressure difference between the upstream and downstream side of the throttle valve, i.e., the pressure difference between the high-pressure side 24 and the low-pressure side 25. For this purpose, a high-pressure stream branching off from the high-pressure side 24 impinges on the turbine wheel 4 as indicated by an arrow 20. A low-pressure stream 21 exiting radially on the inside of the turbine wheel 4 is returned to the low-pressure side 25.

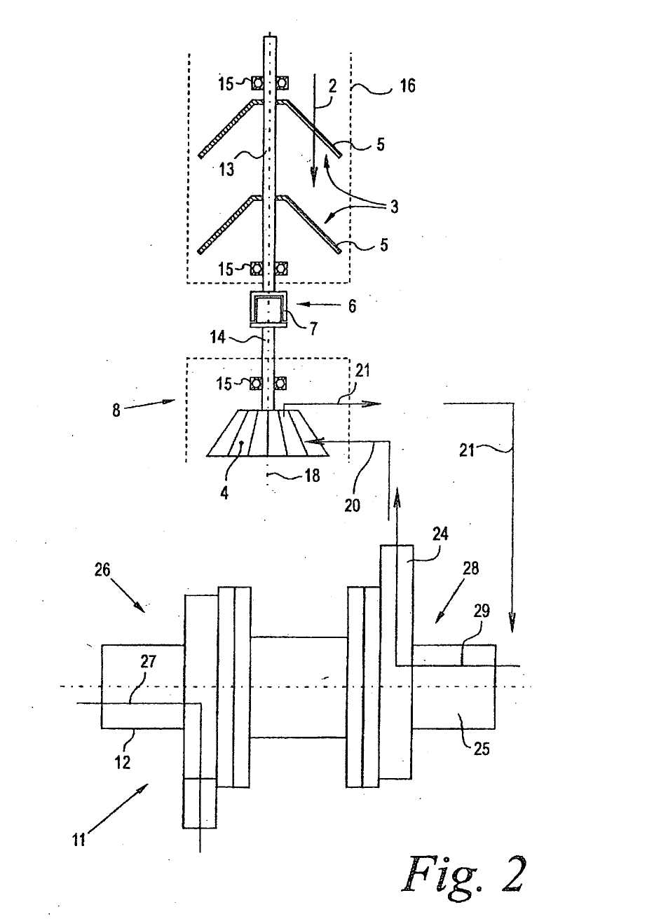

FIG. 2 shows a variant of the apparatus of FIG. 1 in which the pressure difference of a loader or supercharger 11 is used to drive the turbine wheel 4. In the illustrated embodiment, the supercharger 11 is configured as an exhaust driven turbocharger 12. A Roots blower, a compressor, etc., may likewise be provided. The exhaust turbocharger 12 comprises an exhaust turbine 26 and a compressor 28 driven by the exhaust turbine 26. An exhaust stream flows radially through the exhaust turbine 26 from the outside to the inside, approximately along the arrow 27. The mechanical energy obtained thereby drives the compressor 28 such that a combustion air stream is forced from a radially inward low-pressure side 25 to a radially outward high-pressure side 24, approximately along an arrow 29.

To drive the turbine wheel 4, a high-pressure stream 20 is diverted from the combustion airflow 29 in the area of the high-pressure side 24. This diverted gas stream is returned as a low-pressure gas stream from the radial flow turbine 8 to the low-pressure side 25 of the compressor 28, as schematically indicated by the arrows 21.

With respect to the remaining features and reference numerals, the arrangement according to FIG. 2 corresponds to that of FIG. 1. In addition to the embodiments shown, other suitable gas streams may be used to drive the turbine wheel 4. For example, the turbine wheel 4 can be driven by the exhaust stream 27.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A centrifugal separator for separating contaminants entrained in a gas stream, said centrifugal separator comprising at least one rotatable separating member, and a turbine wheel for driving the separating member.

2. A centrifugal separator according to claim 1, wherein the separating member is a disk separator.

3. A centrifugal separator according to claim 1, wherein the rotatable separating member and the turbine wheel are arranged along the same axis.

4. A centrifugal separator according to claim 1, further comprising a coupling interposed between the separating member and the turbine wheel.

5. A centrifugal separator according to claim 4, wherein said coupling is a selectively connectable and disconnectable coupling.

6. A centrifugal separator according to claim 1, wherein the turbine wheel is configured as part of a radial flow turbine.

7. A centrifugal separator according to claim 1, wherein the turbine wheel is driven by a pressure difference across a throttle valve disposed in an air intake tract of an internal combustion engine.

8. A centrifugal separator according to claim 1, wherein the turbine wheel is driven by a pressure difference generated by a loader.

9. A centrifugal separator according to claim 8, wherein said loader is an exhaust driven turbocharger.
